(19) United States
(12) Patent Application Publication
(10) Pub. No.: US 2026/0211220 A1
(43) Pub. Date: Jul. 23, 2026

(54) IMAGING LENS SYSTEM, CAMERA MODULE, IN-VEHICLE SYSTEM, AND VEHICLE

(71) Applicant: Maxell, Ltd., Kyoto (JP)

(72) Inventor: Katsuya UNO, Otokuni-gun, Kyoto (JP)

(73) Assignee: Maxell, Ltd., Kyoto (JP)

(21) Appl. No.: 19/139,869

(22) PCT Filed: Dec. 5, 2023
(86) PCT No.: PCT/JP2023/043488

§ 371 Date: Jun. 17, 2025

(30) Foreign Application Priority Data
Jan. 4, 2023 (JP) 2023-000152

(51) Int. Cl. G02B 13/18; G02B 3/00; G02B 9/62; G02B 13/14; H04N 23/55

(52) U.S. Cl. CPC G02B 13/18; G02B 9/62; G02B 13/146; H04N 23/55; G02B 2003/0093

(57) ABSTRACT

An imaging lens system includes, sequentially from an object side toward an image side, a first lens having negative power with an object-side surface whose convex surface faces the object side; a second lens, which is a meniscus lens with the object-side surface whose concave surface faces the object side; an iris; a third lens with the object-side surface whose convex surface faces the object side and an image-side surface whose convex surface faces the image side; a fourth lens, which is a meniscus lens having negative power with the image-side surface whose concave surface faces the image side; a fifth lens having positive power with the object-side surface whose convex surface faces the object side; and a sixth lens having negative power with the object-side surface whose concave surface faces the object side, in which the imaging lens system satisfies Conditional Expressions (1)-(4).

### TECHNICAL FIELD

The present invention relates to an imaging lens system, a camera module, an in-vehicle system, and a vehicle.

### BACKGROUND ART

In recent years, sensing capabilities for detecting people or objects have been required for wide-angle cameras mounted on cars not only during the daytime but also during the night-time. Further, since sensor sensitivity for near infrared light used for sensing during the night-time is relatively weak, sufficient brightness has been required. In addition, since it is required to perform sensing in not only the exterior of the car but also the interior of the car, a wider-angle imaging lens system has been required. Thus, there has been a need for a wide-angle imaging lens system having a small F number and brightness, with a high resolution in which various aberrations are suppressed in a wide range of wavelength regions from visible light to near infrared light.

Patent Literature 1 discloses an imaging lens system consisting of six lenses capable of dealing with wavelength regions from visible light to infrared light, to be mounted on on-board cameras or the like.

### CITATION LIST

### Patent Literature

[Patent Literature 1] Japanese Unexamined Patent Application Publication No. 2020-109513

### SUMMARY OF INVENTION

### Technical Problem

However, the imaging lens system disclosed in Patent Literature 1 has a problem in that, in this optical system, the F value is 2.4, which relatively low, and the angle of view is 138°, which is relatively narrow.

The present invention has been made in view of such problems, and an object of the present invention is to provide an imaging lens system, a camera module, an in-vehicle system, and a vehicle that have sufficient brightness for sensing capabilities during the night-time, a high resolution in a wide range of wavelength regions from visible light to near infrared light, and a wide angle.

### Solution to Problem

An imaging lens system according to one embodiment includes, sequentially from an object side toward an image side: a first lens having negative power with an object-side surface whose convex surface faces an object side; a second lens, which is a meniscus lens with the object-side surface whose concave surface faces the object side; an iris; a third lens with the object-side surface whose convex surface faces the object side and an image-side surface whose convex surface faces the image side; a fourth lens, which is a meniscus lens having negative power with the image-side surface whose concave surface faces the image side; a fifth lens having positive power with the object-side surface whose convex surface faces the object side; and a sixth lens having negative power with the object-side surface whose concave surface faces the object side, in which the imaging lens system satisfies the following Conditional Expressions (1) to (4):

$$5.5 < f 2 / f < 12. \qquad ( 1 )$$

$$- 4. < f 4 / f < - 2. \qquad ( 2 )$$

$$vd 2 < 30 \qquad ( 3 )$$

$$vd 3 > 60 \qquad ( 4 )$$

where f2 is defined as a focal length of the second lens, f4 is defined as a focal length of the fourth lens, f is defined as a focal length of the entire optical system, vd2 is defined as an Abbe's number for a d-line of the second lens, and vd3 is defined as an Abbe's number for a d-line of the third lens.

### Advantageous Effects of Invention

According to the present invention, it is possible to provide an imaging lens system, a camera module, an in-vehicle system, and a vehicle that have sufficient brightness for sensing capabilities during the night-time, a high resolution in a wide range of wavelength regions from visible light to near infrared light, and a wide angle.

### BRIEF DESCRIPTION OF DRAWINGS

FIG. 1 is a cross-sectional view showing a configuration of a camera module and an imaging lens system according to Example 1;

FIG. 2A is a spherical aberration diagram (longitudinal aberration diagram) of the imaging lens system according to Example 1;

FIG. 2B is a field curvature diagram of the imaging lens system according to Example 1;

FIG. 2C is a distortion diagram of the imaging lens system according to Example 1;

FIG. 3 is a cross-sectional view showing a configuration of a camera module and an imaging lens system according to Example 2;

FIG. 4A is a spherical aberration diagram (longitudinal aberration diagram) of the imaging lens system according to Example 2;

FIG. 4B is a field curvature diagram of the imaging lens system according to Example 2;

FIG. 4C is a distortion diagram of the imaging lens system according to Example 2;

FIG. 5 is a cross-sectional view showing a configuration of a camera module and an imaging lens system according to Example 3;

FIG. 6A is a spherical aberration diagram (longitudinal aberration diagram) of the imaging lens system according to Example 3;

FIG. 6B is a field curvature diagram of the imaging lens system according to Example 3;

FIG. 6C is a distortion diagram of the imaging lens system according to Example 3;

FIG. 7 is a cross-sectional view showing a configuration of a camera module and an imaging lens system according to Example 4;

FIG. 8A is a spherical aberration diagram (longitudinal aberration diagram) of the imaging lens system according to Example 4;

FIG. 8B is a field curvature diagram of the imaging lens system according to Example 4;

FIG. 8C is a distortion diagram of the imaging lens system according to Example 4;

FIG. 9 is a cross-sectional view showing a configuration of a camera module and an imaging lens system according to Example 5;

FIG. 10A is a spherical aberration diagram (longitudinal aberration diagram) of the imaging lens system according to Example 5;

FIG. 10B is a field curvature diagram of the imaging lens system according to Example 5;

FIG. 10C is a distortion diagram of the imaging lens system according to Example 5;

FIG. 11 is an overview diagram of a car including an in-vehicle system with a camera module according to an embodiment of the present disclosure; and

FIG. 12 is a block diagram showing a configuration of a capturing apparatus constituting the in-vehicle system of FIG. 11.

### DESCRIPTION OF EMBODIMENTS

An embodiment of the present disclosure will be described below with reference to the drawings. In this embodiment, a highly reliable system can be implemented, especially in a sensing system, and contributes to the development of a resilient infrastructure. The targets of this embodiment are “3. Ensure healthy lives and promote well-being for all at all ages” of the United Nations Sustainable Development Goals (SDGs), “3.6 By 2020, halve the number of global deaths and injuries from road traffic accidents” and “9. Build resilient infrastructure, promote inclusive and sustainable industrialization and foster innovation” of the SDGs, “9.1 Develop quality, reliable, sustainable and resilient infrastructure, including regional and transborder infrastructure, to support economic development and human well-being, with a focus on affordable and equitable access for all”.

### First Embodiment: Imaging Lens System

An imaging lens system according to a first embodiment includes, sequentially from an object side toward an image side:
a first lens having negative power with an object-side surface whose convex surface faces the object side; a second lens, which is a meniscus lens with the object-side surface whose concave surface faces the object side; an iris; a third lens with the object-side surface whose convex surface faces the object side and an image-side surface whose convex surface faces the image side; a fourth lens, which is a meniscus lens having negative power with the image-side surface whose concave surface faces the image side; a fifth lens having positive power with the object-side surface whose convex surface faces the object side; and a sixth lens having negative power with the object-side surface whose concave surface faces the object side, wherein
the imaging lens system satisfies the following Conditional Expressions (1) to (4):

$$5.5 < f 2 / f < 12. \qquad ( 1 )$$

$$- 4. < f 4 / f < - 2. \qquad ( 2 )$$

$$vd 2 < 30 \qquad ( 3 )$$

$$vd 3 > 60 \qquad ( 4 )$$

where f2 is defined as a focal length of the second lens, f4 is defined as a focal length of the fourth lens, f is defined as a focal length of the entire optical system, vd2 is defined as an Abbe's number for a d-line of the second lens, and vd3 is defined as an Abbe's number for a d-line of the third lens.

Thus, a wide-angle imaging lens system that has sufficient brightness for sensing capabilities during the night-time and has a high resolution in a wide range of wavelength regions from visible light to near infrared light can be provided.

Specifically, since the object-side surface of the second lens has a concave surface facing the object side, astigmatism generated in the object-side surface of the first lens can be corrected, and a wide angle can be enabled.

Further, when the value of f2/f is 12.0 or greater, the focal length of the second lens becomes too long with respect to the focal length of the entire optical system, i.e., the power of the second lens becomes too weak, and the field curvature generated in the object-side surface of the first lens cannot be sufficiently corrected in the second lens. The value of f2/f is more preferably 10.5 or less.

Further, when the value of f2/f is 5.5 or less, the focal length of the second lens becomes too short with respect to the focal length of the entire optical system, i.e., the power of the second lens becomes too strong, and the lateral color aberration generated in the first lens cannot be sufficiently corrected in the image-side surface of the second lens. The value of f2/f is more preferably 6.0 or greater.

Further, when the value of f4/f is-4.0 or less, the focal length of the fourth lens becomes too long with respect to the focal length of the entire optical system, i.e., the power of the fourth lens becomes too weak, and the field curvature generated in the object-side surface of the first lens cannot be sufficiently corrected in the fourth lens. The value of f4/f is more preferably-3.6 or greater.

Further, when the value of f4/f is-2.0 or greater, the focal length of the fourth lens becomes too short with respect to the focal length of the entire optical system, i.e., the power of the fourth lens becomes too strong, the spherical aberration cannot be sufficiently corrected in the fourth lens, and the imaging lens system cannot have a sufficient brightness. The value of f4/f is more preferably-2.4 or less.

Further, when the value of vd2 is 30 or greater, it becomes difficult to sufficiently correct the chromatic aberration generated in the first lens, whereby it becomes difficult to achieve a balanced suppression in focus shift due to chromatic aberrations in wavelength regions of both the visible light and the near infrared light.

Further, when the value of vd3 is 60 or greater, it becomes difficult to sufficiently correct the chromatic aberration generated in the first lens, whereby it becomes difficult to achieve a balanced suppression in focus shift due to chromatic aberrations in wavelength regions of both the visible light and the near infrared light.

As a result, since the imaging lens system satisfies the Conditional Expressions (1)-(4), a wide-angle imaging lens system that has sufficient brightness for sensing capabilities during the night-time and has a high resolution in a wide range of wavelength regions from visible light to near infrared light can be provided.

Further, the imaging lens system preferably satisfies the following Conditional Expression (5):

$$- 3.5 < f 6 / f < - 2.1 \qquad ( 5 )$$

where f6 is defined as a focal length of the sixth lens.

Since the imaging lens system satisfies the above Conditional Expression (5), the field curvature and the distortion generated in the first lens can be corrected in the sixth lens. Specifically, when the value of f6/f is −3.5 or less, the power of the sixth lens becomes too weak, and the field curvature and the distortion generated in the first lens cannot be sufficiently corrected. The value of f6/f is more preferably −3.1 or greater. On the other hand, when the value of f6/f is −2.1 or greater, the power of the sixth lens becomes too strong, and correction of the field curvature and the distortion generated in the first lens becomes excessive. The value of f6/f is more preferably −2.5 or less.

Further, the imaging lens system preferably satisfies the following Conditional Expression (6):

$$- 0.8 < f 5 / f 6 < - 0.5 \qquad ( 6 )$$

where f5 is defined as a focal length of the fifth lens and f6 is defined as a focal length of the sixth lens.

Since the imaging lens system satisfies the above Conditional Expression (6), chromatic aberrations in the entire optical system can be effectively corrected in the fifth lens and the sixth lens. Specifically, when the above Conditional Expression (6) is not satisfied, the power of the fifth lens and the power of the sixth lens become unbalanced, and it becomes difficult to perform effective correction of chromatic aberrations in the entire optical system. The value of f5/f6 is more preferably-0.7 or greater. Further, the value of f5/f6 is more preferably-0.6 or less.

Further, the imaging lens system preferably satisfies the following Conditional Expression (7):

$$3.5 < f 2 / f 3 < 7.5 \qquad ( 7 )$$

where f3 is defined as a focal length of the third lens.

Since the imaging lens system satisfies the above Conditional Expression (7), the spherical aberrations in the entire optical system can be effectively corrected. Specifically, when the above Conditional Expression (7) is not satisfied, the power of the second lens and the power of the third lens become unbalanced, and it becomes difficult to perform effective correction of spherical aberrations in the entire optical system. The value of f2/f3 is more preferably 3.9 or greater, and further preferably 4.7 or greater. Further, the value of f2/f3 is more preferably 7.0 or less, and further preferably 6.0 or less.

### Second Embodiment: Camera Module

A camera module according to a second embodiment includes the imaging lens system described above and a capturing element arranged at a focal position of the imaging lens system and configured to convert light condensed through the imaging lens system into an electrical signal. Thus, a wide-angle camera module that has sufficient brightness for sensing capabilities during the night-time and has a high resolution in a wide range of wavelength regions from visible light to near infrared light can be provided.

Next, examples of the imaging lens system according to the first embodiment and the camera module according to the second embodiment will be described with reference to the drawings.

### Example 1

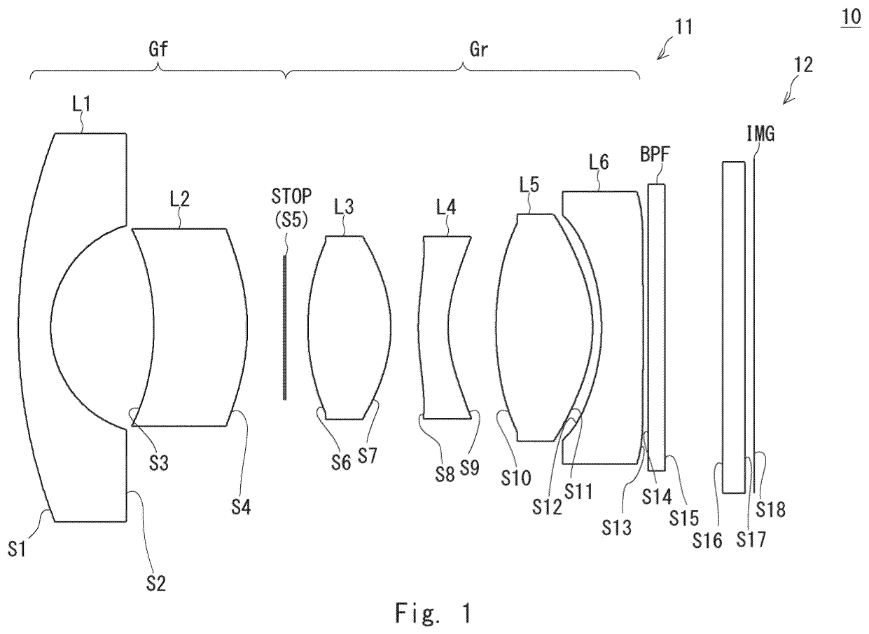

FIG. 1 is a cross-sectional view showing a configuration of a camera module 10 according to Example 1. Specifically, the camera module 10 includes an imaging lens system 11 and a capturing element 12. The imaging lens system 11 and the capturing element 12 are housed in a lens barrel (not shown).

The capturing element 12 is an element for converting received light into an electric signal, and for example, a CCD image sensor or a CMOS image sensor is used. The capturing element 12 is arranged at an imaging position (focal position) of the imaging lens system 11.

The imaging lens system 11 according to Example 1 is composed of a front lens group Gf composed of a first lens L1 and a second lens L2, an aperture iris (STOP), and a rear lens group Gr composed of a third lens L3, a fourth lens L4, a fifth lens L5, and a sixth lens L6, which are arranged in this order from the object side toward the image side. A focal plane of the imaging lens system 11 is shown by IMG. The first lens L1 and the third lens L3 are glass lenses. The second lens L2, the fourth lens L4, the fifth lens L5, and the sixth lens L6 are plastic lenses.

Note that an optical filter (visible/infrared light band-pass filter, or the like) is arranged between the imaging lens system 11 and the capturing element 12, as necessary. Descriptions will be made herein with an example in which a visible/infrared light band-pass filter (BPF) is arranged between the imaging lens system 11 and the capturing element 12.

The first lens L1 has negative power. An object-side surface S1 of the first lens L1 has a spherical shape with a convex surface facing the object side. An image-side surface S2 of the first lens L1 has a spherical shape with a concave surface facing the image side.

The second lens L2 is a meniscus lens having positive power. An object-side surface S3 of the second lens L2 has an aspherical surface shape with a concave surface facing the object side. An image-side surface S4 of the second lens L2 has an aspherical surface shape with a convex surface facing the image side.

The iris STOP is an aperture iris that determines an F value (F-number, Fno) of a lens system. The iris STOP is arranged between the second lens L2 and the third lens L3.

The third lens L3 has positive power. An object-side surface S6 of the third lens L3 has an aspherical surface shape with a convex surface facing the object side. An image-side surface S7 of the third lens L3 has an aspherical surface shape with a convex surface facing the image side.

The fourth lens L4 is a meniscus lens having negative power. An object-side surface S8 of the fourth lens L4 has an aspherical surface shape with a convex surface facing the object side. Further, an image-side surface S9 of the fourth lens L4 has an aspherical surface shape with a concave surface facing the image side.

The fifth lens L5 has positive power. An object-side surface S10 of the fifth lens L5 has an aspherical surface shape with a convex surface facing the object side. Further, an image-side surface S11 of the fifth lens L5 has an aspherical surface shape with a convex surface facing the image side.

The sixth lens L6 has negative power. An object-side surface S12 of the sixth lens L6 has an aspherical surface shape with a concave surface facing the object side. Further, an image-side surface S13 of the sixth lens L6 has an aspherical surface shape with a convex surface facing the image side.

The visible/infrared light band-pass filter (BPF) is a filter for causing only the light in predetermined visible/near infrared light regions to pass. When the imaging lens system 11 is designed, the imaging lens system 11 and the visible/infrared light band-pass filter are handled as one integrated component. However, the visible/infrared light band-pass filter is not an essential component of the imaging lens system 11. The visible/infrared light band-pass filter is disposed on the image side of the sixth lens L6.

A sensor cover glass for preventing adhesion of dust to the capturing element 12 may be arranged between the visible/infrared light band-pass filter and the capturing element 12.

Table 1 shows lens data of each lens surface in the imaging lens system 11 according to Example 1. Table 1 shows, as the lens data, a curvature radius (mm), a thickness (mm) between surfaces on the central optical axis, a refractive index nd for a d-line, and an Abbe's number vd for the d-line, of each surface. In Table 1, surfaces marked with “*” are aspherical surfaces. Further, in the imaging lens system 11 according to Example 1, the F-number is 2.0 and the angle of view is 180°

TABLE 1

| | Curvature | | | |
|---|---|---|---|---|
| | Radius | Thickness | | |
| Surface Number | (mm) | (mm) | nd | νd |
| Lens Surface S1 | 9.416 | 0.572 | 1.816 | 46.6 |
| Lens Surface S2 | 1.879 | 1.844 | | |
| Lens Surface S3 * | −4.187 | 1.671 | 1.635 | 24.0 |
| Lens Surface S4 * | −3.550 | 0.655 | | |
| Aperture Surface S5 | INF | 0.424 | | |
| Lens Surface S6 * | 3.999 | 1.485 | 1.438 | 94.5 |
| Lens Surface S7 * | −2.398 | 0.490 | | |
| Lens Surface S8 * | 4.349 | 0.532 | 1.661 | 20.4 |
| Lens Surface S9 * | 2.187 | 0.860 | | |
| Lens Surface S10 * | 5.669 | 1.725 | 1.537 | 56.4 |
| Lens Surface S11 * | −2.462 | 0.161 | | |
| Lens Surface S12 * | −3.137 | 0.742 | 1.635 | 24.0 |
| Lens Surface S13 * | −28.416 | 0.085 | | |
| BPF Surface S14 | INF | 0.300 | 1.517 | 64.2 |
| BPF Surface S15 | INF | 1.035 | | |
| Cover Surface S16 | INF | 0.400 | 1.517 | 64.2 |
| Cover Surface S17 | INF | 0.130 | | |
| IMG Surface S18 | INF | 0.000 | | |

The aspherical surface shape adopted for the lens surface is expressed by the below-shown expression, in which z is a sag; c is the inverse of the curvature radius; k is a conic constant; r is a height of a ray from an optical axis; and α₄, α₆, α₈, α₁₀, α₁₂, α₁₄, and α₁₆ are 4th, 6th, 8th, 10th, 12th, 14th, and 16th order aspherical surface coefficients, respectively.

$$z = \frac{c {r}^{2}}{1 + \sqrt{1 - ( 1 + k ) {c}^{2} {r}^{2}}} + {α}_{4} {r}^{4} + {α}_{6} {r}^{6} + {α}_{8} {r}^{8} + {α}_{10} {r}^{10} + {α}_{12} {r}^{12} + {α}_{14} {r}^{14} + {α}_{16} {r}^{16} \qquad [ Expression 1 ]$$

Table 2 shows aspherical surface coefficients for defining aspherical surface shapes of aspherical lens surfaces in the imaging lens system 11 according to Example 1. Note that, in Table 2, for example, “−1.71926E-03” means “−1.71926×10⁻³”. The above-described numerical explanations apply to other tables shown later.

TABLE 2

| | k | α₄ | α₆ | α₈ |
|---|---|---|---|---|
| Lens Surface S3 | 0.000 | 1.10420E−03 | −1.71926E−03 | 9.00260E−04 |
| Lens Surface S4 | 0.000 | 9.88184E−03 | −2.65370E−03 | 1.59167E−03 |
| Lens Surface S6 | 0.000 | 7.83129E−03 | −2.13262E−03 | 1.25376E−04 |
| Lens Surface S7 | 0.000 | 1.64936E−02 | 7.22231E−05 | 1.54784E−04 |
| Lens Surface S8 | 0.000 | −3.97264E−02 | 2.84275E−03 | −8.95327E−05 |
| Lens Surface S9 | 0.000 | −5.20734E−02 | 5.94463E−03 | −1.02876E−03 |
| Lens Surface S10 | 0.000 | 4.15889E−03 | 8.15132E−04 | −1.45093E−04 |
| Lens Surface S11 | 0.000 | 1.40711E−02 | 2.62487E−03 | −2.62435E−04 |
| Lens Surface S12 | 0.000 | 9.34511E−03 | 1.39186E−04 | −5.57787E−04 |
| Lens Surface S13 | 0.000 | 1.06008E−02 | −2.39145E−03 | 7.98020E−05 |

| | α₁₀ | α₁₂ | α₁₄ | α₁₆ |
|---|---|---|---|---|
| Lens Surface S3 | −2.92255E−04 | 3.17350E−05 | 0.00000E+00 | 0.00000E+00 |
| Lens Surface S4 | −5.36981E−04 | 8.42472E−05 | 0.00000E+00 | 0.00000E+00 |
| Lens Surface S6 | 0.00000E+00 | 0.00000E+00 | 0.00000E+00 | 0.00000E+00 |
| Lens Surface S7 | 0.00000E+00 | 0.00000E+00 | 0.00000E+00 | 0.00000E+00 |
| Lens Surface S8 | 2.37793E−05 | 0.00000E+00 | 0.00000E+00 | 0.00000E+00 |
| Lens Surface S9 | 2.62683E−05 | 0.00000E+00 | 0.00000E+00 | 0.00000E+00 |
| Lens Surface S10 | 2.94555E−06 | 0.00000E+00 | 0.00000E+00 | 0.00000E+00 |
| Lens Surface S11 | −1.29898E−06 | 0.00000E+00 | 0.00000E+00 | 0.00000E+00 |
| Lens Surface S12 | −4.72701E−06 | 0.00000E+00 | 0.00000E+00 | 0.00000E+00 |
| Lens Surface S13 | 5.78639E−07 | 0.00000E+00 | 0.00000E+00 | 0.00000E+00 |

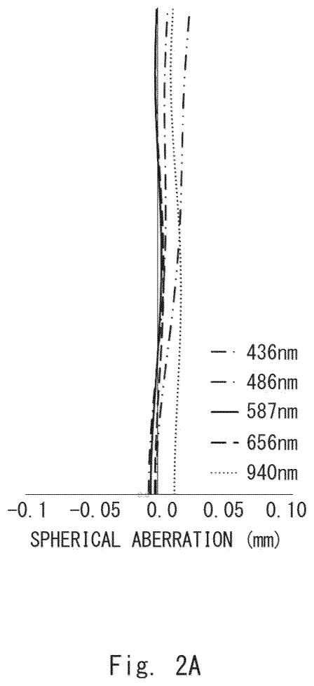

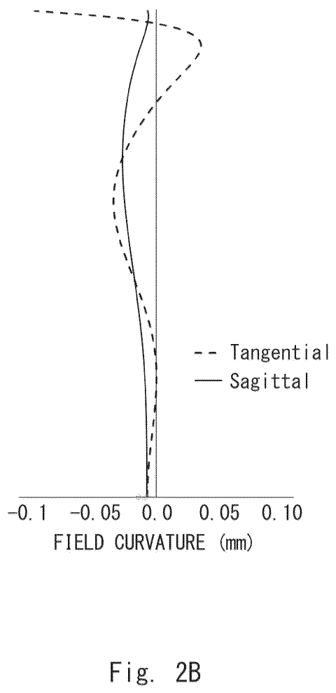

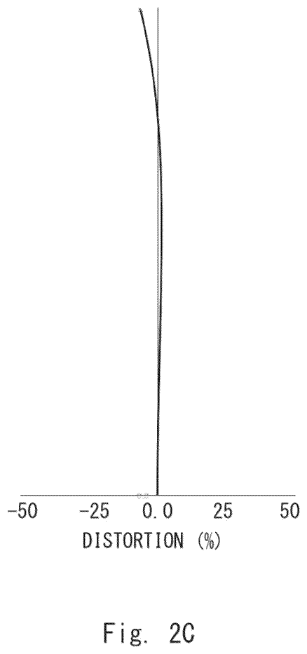

Next, an aberration will be described with reference to the drawings. FIGS. 2A to 2C show a spherical aberration diagram (longitudinal aberration diagram), a field curvature diagram, and a distortion diagram in the imaging lens system 11 according to Example 1.

In the longitudinal aberration diagram of FIG. 2A, the horizontal axis indicates positions at which the ray intersects the optical axis, and the vertical axis indicates passing heights of rays on the incident pupil. Further, FIG. 2A shows results of simulations by 436 nm, 486 nm (F-line), 587 nm (d-line), 656 nm (C-line), and 940 nm (near infrared light).

In the field curvature diagram of FIG. 2B, the horizontal axis indicates distances in the direction of the optical axis, and the vertical axis indicates image heights (angle of view). In the field curvature diagram of FIG. 2B, Sagittal indicates the imaging position in the sagittal ray, and Tangential indicates the imaging position in the tangential ray. FIG. 2B shows a result of simulation by the d-line.

In the distortion diagram of FIG. 2C, the horizontal axis indicates distortion (%) of an image, and the vertical axis indicates image heights (angle of view). FIG. 2C shows a result of simulation by a ray of the d-line.

### Example 2

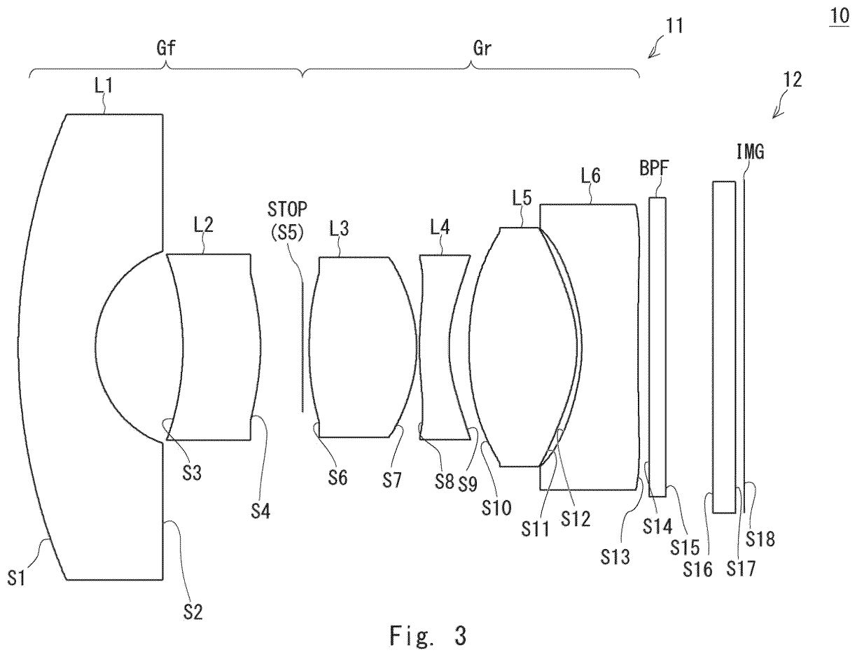

FIG. 3 is a cross-sectional view showing the camera module 10 according to Example 2. Since the imaging lens system 11 according to Example 2 has the same lens configuration as that of Example 1 except for the point that the image-side surface S13 of the sixth lens L6 has an aspherical surface shape with a concave surface facing the image side, descriptions thereof will be omitted. Hereinafter, property data of the imaging lens system 11 according to Example 2 will be described.

Table 3 shows lens data of each lens surface in the imaging lens system 11 according to Example 2. Since the items shown in Table 3 are the same as those in Table 1, descriptions thereof are omitted.

TABLE 3

| | Curvature | | | |
|---|---|---|---|---|
| | Radius | Thickness | | |
| Surface Number | (mm) | (mm) | nd | νd |
| Lens Surface S1 | 10.380 | 1.388 | 1.755 | 52.3 |
| Lens Surface S2 | 1.812 | 1.564 | | |
| Lens Surface S3 * | −4.770 | 1.398 | 1.635 | 24.0 |
| Lens Surface S4 * | −3.940 | 0.754 | | |
| Aperture Surface S5 | INF | 0.120 | | |
| Lens Surface S6 * | 5.924 | 1.930 | 1.620 | 63.8 |
| Lens Surface S7 * | −2.539 | 0.046 | | |
| Lens Surface S8 * | 4.708 | 0.531 | 1.661 | 20.4 |
| Lens Surface S9 * | 2.252 | 0.363 | | |
| Lens Surface S10 * | 5.288 | 1.937 | 1.537 | 56.4 |
| Lens Surface S11 * | −2.398 | 0.082 | | |
| Lens Surface S12 * | −3.047 | 1.016 | 1.635 | 24.0 |
| Lens Surface S13 * | 67.474 | 0.195 | | |
| BPF Surface S14 | INF | 0.300 | 1.517 | 64.2 |
| BPF Surface S15 | INF | 0.854 | | |
| Cover Surface S16 | INF | 0.400 | 1.517 | 64.2 |
| Cover Surface S17 | INF | 0.145 | | |
| IMG Surface S18 | INF | 0.000 | | |

Table 4 shows aspherical surface coefficients for defining aspherical surface shapes of aspherical lens surfaces in the imaging lens system 11 according to Example 2. In Table 4, the aspherical surface shape adopted for the lens surface is expressed by an expression similar to that in Example 1.

TABLE 4

| | k | α₄ | α₆ | α₈ |
|---|---|---|---|---|
| Lens Surface S3 | 0.000 | 6.68606E−04 | 1.46969E−04 | −2.35364E−04 |
| Lens Surface S4 | 0.000 | 1.59987E−02 | −1.73572E−03 | −3.42883E−04 |
| Lens Surface S6 | 0.000 | 1.47102E−02 | −3.42679E−03 | −1.81436E−04 |
| Lens Surface S7 | 0.000 | 1.34813E−02 | −3.52828E−05 | −4.53284E−04 |
| Lens Surface S8 | 0.000 | −4.94145E−02 | 4.97758E−03 | −9.06028E−04 |
| Lens Surface S9 | 0.000 | −5.66778E−02 | 8.07246E−03 | −1.24060E−03 |
| Lens Surface S10 | 0.000 | 1.15685E−02 | −9.40445E−04 | 1.11933E−05 |
| Lens Surface S11 | 0.000 | 2.99845E−02 | −1.07994E−03 | 1.92094E−04 |
| Lens Surface S12 | 0.000 | 1.89343E−02 | −2.12093E−03 | −2.07894E−04 |
| Lens Surface S13 | 0.000 | 2.13059E−03 | −6.98243E−04 | 6.79101E−06 |

| | α₁₀ | α₁₂ | α₁₄ | α₁₆ |
|---|---|---|---|---|
| Lens Surface S3 | 1.78505E−06 | 6.66487E−06 | 0.00000E+00 | 0.00000E+00 |
| Lens Surface S4 | 5.45479E−04 | −1.04134E−04 | 0.00000E+00 | 0.00000E+00 |
| Lens Surface S6 | 0.00000E+00 | 0.00000E+00 | 0.00000E+00 | 0.00000E+00 |
| Lens Surface S7 | 0.00000E+00 | 0.00000E+00 | 0.00000E+00 | 0.00000E+00 |
| Lens Surface S8 | 0.00000E+00 | 0.00000E+00 | 0.00000E+00 | 0.00000E+00 |
| Lens Surface S9 | 0.00000E+00 | 0.00000E+00 | 0.00000E+00 | 0.00000E+00 |
| Lens Surface S10 | 0.00000E+00 | 0.00000E+00 | 0.00000E+00 | 0.00000E+00 |
| Lens Surface S11 | 0.00000E+00 | 0.00000E+00 | 0.00000E+00 | 0.00000E+00 |
| Lens Surface S12 | 0.00000E+00 | 0.00000E+00 | 0.00000E+00 | 0.00000E+00 |
| Lens Surface S13 | 0.00000E+00 | 0.00000E+00 | 0.00000E+00 | 0.00000E+00 |

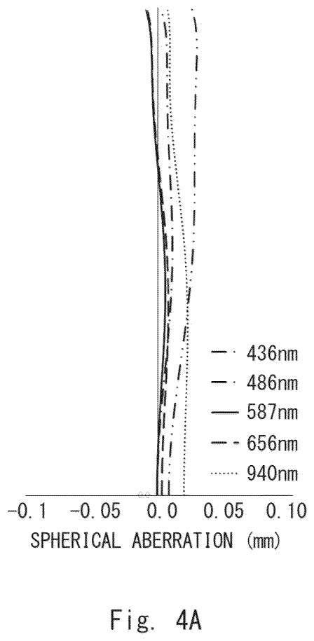

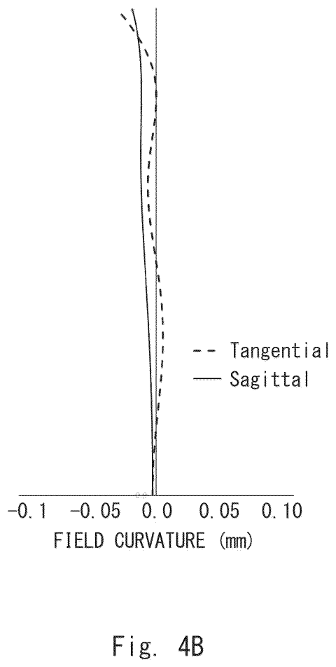

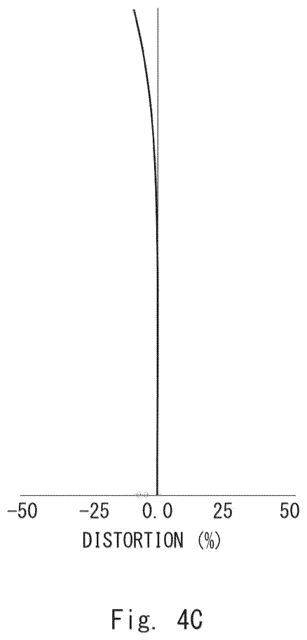

FIGS. 4A to 4C show a spherical aberration diagram (longitudinal aberration diagram), a field curvature diagram, and a distortion diagram in the imaging lens system 11 according to Example 2. Since the description of each aberrations diagram shown in FIGS. 4A to 4C is the same as that of FIGS. 2A to 2C, descriptions thereof will be omitted.

### Example 3

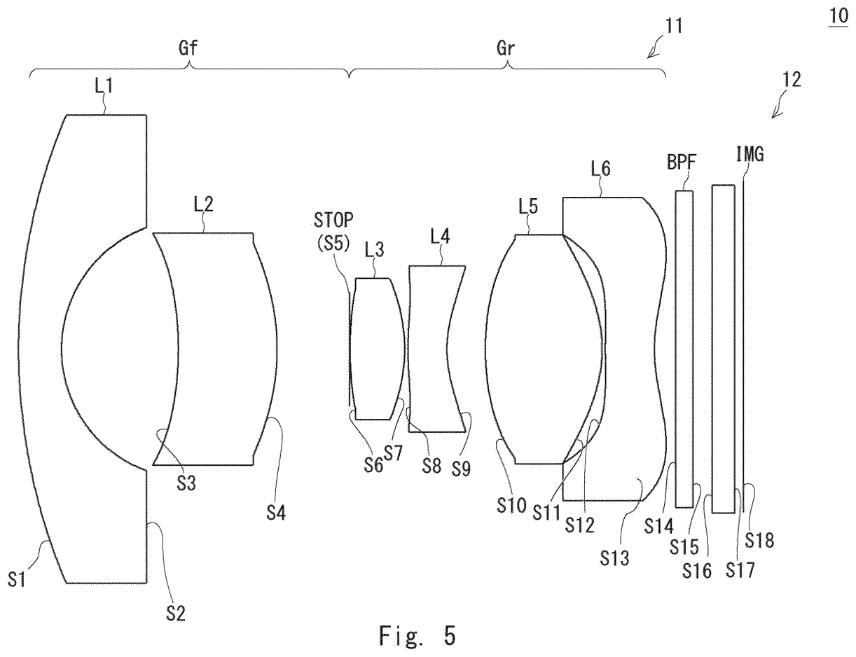

FIG. 5 is a cross-sectional view showing the camera module 10 according to Example 3. Since the imaging lens system 11 according to Example 3 has the same lens configuration as that of Example 1 except for the point that the object-side surface S12 of the sixth lens L6 has an aspherical surface shape with a convex surface facing the object side and that the image-side surface S13 has an aspherical surface shape with a concave surface facing the image side, descriptions thereof will be omitted. Hereinafter, property data of the imaging lens system 11 according to Example 3 will be described.

Table 5 shows lens data of each lens surface in the imaging lens system 11 according to Example 3. Since the items shown in Table 5 are the same as those in Table 1, descriptions thereof are omitted.

TABLE 5

| | Curvature | | | |
|---|---|---|---|---|
| | Radius | Thickness | | |
| Surface Number | (mm) | (mm) | nd | νd |
| Lens Surface S1 | 10.656 | 0.772 | 1.755 | 52.3 |
| Lens Surface S2 | 2.297 | 2.098 | | |
| Lens Surface S3 * | −6.008 | 1.783 | 1.635 | 24.0 |
| Lens Surface S4 * | −3.902 | 1.298 | | |
| Aperture Surface S5 | INF | 0.016 | | |
| Lens Surface S6 * | 7.160 | 0.976 | 1.620 | 63.8 |
| Lens Surface S7 * | −2.825 | 0.064 | | |
| Lens Surface S8 * | 6.149 | 0.700 | 1.661 | 20.4 |
| Lens Surface S9 * | 2.069 | 0.695 | | |
| Lens Surface S10 * | 5.151 | 2.093 | 1.537 | 56.4 |
| Lens Surface S11 * | −2.371 | 0.062 | | |
| Lens Surface S12 * | 25.529 | 0.883 | 1.635 | 24.0 |
| Lens Surface S13 * | 2.980 | 0.387 | | |
| BPF Surface S14 | INF | 0.300 | 1.517 | 64.2 |
| BPF Surface S15 | INF | 0.355 | | |
| Cover Surface S16 | INF | 0.400 | 1.517 | 64.2 |
| Cover Surface S17 | INF | 0.147 | | |
| IMG Surface S18 | INF | 0.000 | | |

Table 6 shows aspherical surface coefficients for defining aspherical surface shapes of aspherical lens surfaces in the imaging lens system 11 of Example 3. In Table 6, the aspherical surface shape adopted for the lens surface is expressed by an expression similar to that in Example 1.

TABLE 6

| | k | α₄ | α₆ | α₈ |
|---|---|---|---|---|
| Lens Surface S3 | 0.000 | −1.23472E−03 | −1.52617E−03 | 4.33334E−04 |
| Lens Surface S4 | 0.000 | 7.94708E−03 | −3.03669E−03 | 1.19994E−03 |
| Lens Surface S6 | 0.000 | 1.38018E−02 | −4.81334E−03 | 0.00000E+00 |
| Lens Surface S7 | 0.000 | 1.91804E−02 | −4.20946E−03 | 0.00000E+00 |
| Lens Surface S8 | 0.000 | −5.29076E−02 | 7.35524E−03 | −4.13356E−04 |
| Lens Surface S9 | 0.000 | −7.85971E−02 | 1.47017E−02 | −2.72171E−03 |
| Lens Surface S10 | 0.000 | 1.49729E−02 | −2.79451E−03 | 3.62856E−04 |
| Lens Surface S11 | 0.000 | 2.76769E−02 | −4.16512E−03 | 9.05697E−04 |
| Lens Surface S12 | 0.000 | −3.74444E−02 | −4.18833E−03 | 3.19626E−04 |
| Lens Surface S13 | 0.000 | −4.75500E−02 | 4.09188E−03 | −3.50176E−04 |

| | α₁₀ | α₁₂ | α₁₄ | α₁₆ |
|---|---|---|---|---|
| Lens Surface S3 | −1.17084E−04 | 1.15933E−05 | 0.00000E+00 | 0.00000E+00 |
| Lens Surface S4 | −2.78695E−04 | 3.00841E−05 | 0.00000E+00 | 0.00000E+00 |
| Lens Surface S6 | 0.00000E+00 | 0.00000E+00 | 0.00000E+00 | 0.00000E+00 |
| Lens Surface S7 | 0.00000E+00 | 0.00000E+00 | 0.00000E+00 | 0.00000E+00 |
| Lens Surface S8 | 0.00000E+00 | 0.00000E+00 | 0.00000E+00 | 0.00000E+00 |
| Lens Surface S9 | 0.00000E+00 | 0.00000E+00 | 0.00000E+00 | 0.00000E+00 |
| Lens Surface S10 | 0.00000E+00 | 0.00000E+00 | 0.00000E+00 | 0.00000E+00 |
| Lens Surface S11 | 0.00000E+00 | 0.00000E+00 | 0.00000E+00 | 0.00000E+00 |
| Lens Surface S12 | 0.00000E+00 | 0.00000E+00 | 0.00000E+00 | 0.00000E+00 |
| Lens Surface S13 | 0.00000E+00 | 0.00000E+00 | 0.00000E+00 | 0.00000E+00 |

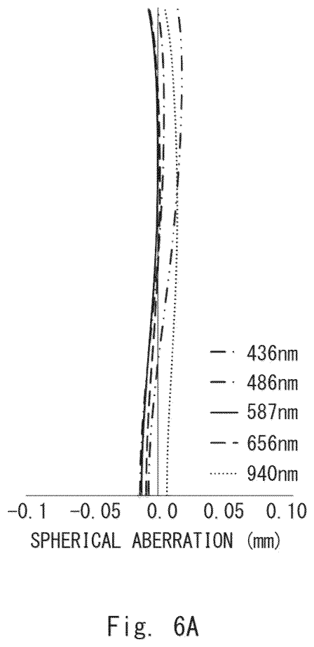

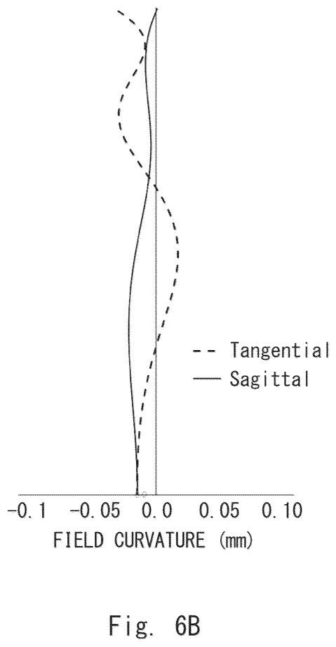

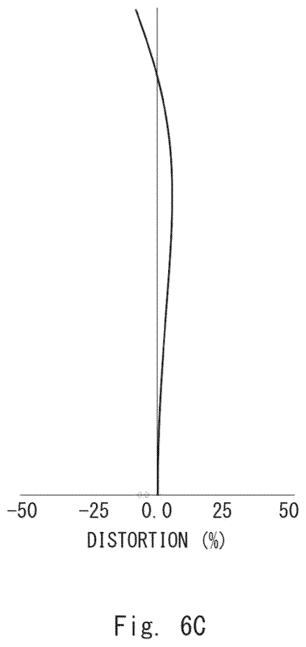

FIGS. 6A to 6C show a spherical aberration diagram (longitudinal aberration diagram), a field curvature diagram, and a distortion diagram in the imaging lens system 11 of Example 3. Since the description of each aberration diagram shown in FIGS. 6A to 6C is the same as that of FIGS. 2A to 2C, the description thereof will be omitted.

### Example 4

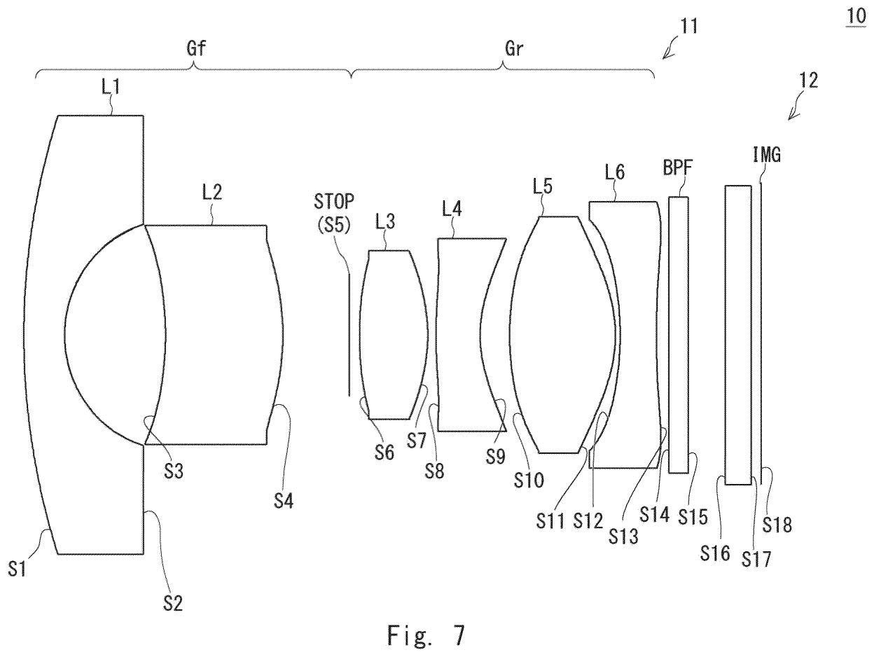

FIG. 7 is a cross-sectional view showing the camera module 10 according to Example 4. Since the imaging lens system 11 according to Example 4 has the same lens configuration as that of Example 2, descriptions thereof will be omitted. Hereinafter, property data of the imaging lens system 11 according to Example 4 will be described.

Table 7 shows lens data of each lens surface in the imaging lens system 11 according to Example 4. Since the items shown in Table 7 are the same as those in Table 1, descriptions thereof are omitted.

TABLE 7

| | Curvature | | | |
|---|---|---|---|---|
| | Radius | Thickness | | |
| Surface Number | (mm) | (mm) | nd | νd |
| Lens Surface S1 | 10.350 | 0.633 | 1.755 | 52.3 |
| Lens Surface S2 | 1.720 | 1.563 | | |
| Lens Surface S3 * | −4.667 | 1.815 | 1.635 | 24.0 |
| Lens Surface S4 * | −3.485 | 1.025 | | |
| Aperture Surface S5 | INF | 0.163 | | |
| Lens Surface S6 * | 5.240 | 1.048 | 1.620 | 63.8 |
| Lens Surface S7 * | −2.513 | 0.126 | | |
| Lens Surface S8 * | 5.248 | 0.689 | 1.661 | 20.4 |
| Lens Surface S9 * | 1.834 | 0.454 | | |
| Lens Surface S10 * | 4.241 | 1.636 | 1.537 | 56.4 |
| Lens Surface S11 * | −2.030 | 0.073 | | |
| Lens Surface S12 * | −4.388 | 0.560 | 1.635 | 24.0 |
| Lens Surface S13 * | 13.371 | 0.191 | | |
| BPF Surface S14 | INF | 0.300 | 1.517 | 64.2 |
| BPF Surface S15 | INF | 0.577 | | |
| Cover Surface S16 | INF | 0.400 | 1.517 | 64.2 |
| Cover Surface S17 | INF | 0.149 | | |
| IMG Surface S18 | INF | 0.000 | | |

Table 8 shows aspherical surface coefficients for defining aspherical surface shapes of aspherical lens surfaces in the imaging lens system 11 of Example 4. In Table 8, the aspherical surface shape adopted for the lens surface is expressed by an expression similar to that in Example 1.

TABLE 8

| | k | α₄ | α₆ | α₈ |
|---|---|---|---|---|
| Lens Surface S3 | 0.000 | −2.82083E−03 | −6.54423E−04 | 9.39901E−05 |
| Lens Surface S4 | 0.000 | 1.14988E−02 | −9.04534E−04 | 1.02832E−04 |
| Lens Surface S6 | 0.000 | 1.50970E−02 | −2.41682E−03 | 0.00000E+00 |
| Lens Surface S7 | 0.000 | 2.25592E−02 | −1.37247E−03 | 0.00000E+00 |
| Lens Surface S8 | 0.000 | −5.05755E−02 | 3.61842E−03 | −4.79337E−04 |
| Lens Surface S9 | 0.000 | −7.43051E−02 | 1.16798E−02 | −4.06085E−03 |
| Lens Surface S10 | 0.000 | 9.47123E−03 | 1.59750E−03 | −4.98436E−04 |
| Lens Surface S11 | 0.000 | 3.51393E−02 | 1.32881E−04 | 1.01967E−03 |
| Lens Surface S12 | 0.000 | 2.33577E−03 | −1.42990E−03 | −1.35249E−03 |
| Lens Surface S13 | 0.000 | 4.61518E−03 | −3.74220E−03 | 6.01434E−05 |

| | α₁₀ | α₁₂ | α₁₄ | α₁₆ |
|---|---|---|---|---|
| Lens Surface S3 | −5.59692E−05 | 7.31729E−06 | 0.00000E+00 | 0.00000E+00 |
| Lens Surface S4 | 1.80417E−04 | 6.51147E−06 | 0.00000E+00 | 0.00000E+00 |
| Lens Surface S6 | 0.00000E+00 | 0.00000E+00 | 0.00000E+00 | 0.00000E+00 |
| Lens Surface S7 | 0.00000E+00 | 0.00000E+00 | 0.00000E+00 | 0.00000E+00 |
| Lens Surface S8 | 0.00000E+00 | 0.00000E+00 | 0.00000E+00 | 0.00000E+00 |
| Lens Surface S9 | 0.00000E+00 | 0.00000E+00 | 0.00000E+00 | 0.00000E+00 |
| Lens Surface S10 | 0.00000E+00 | 0.00000E+00 | 0.00000E+00 | 0.00000E+00 |
| Lens Surface S11 | 0.00000E+00 | 0.00000E+00 | 0.00000E+00 | 0.00000E+00 |
| Lens Surface S12 | 0.00000E+00 | 0.00000E+00 | 0.00000E+00 | 0.00000E+00 |
| Lens Surface S13 | 0.00000E+00 | 0.00000E+00 | 0.00000E+00 | 0.00000E+00 |

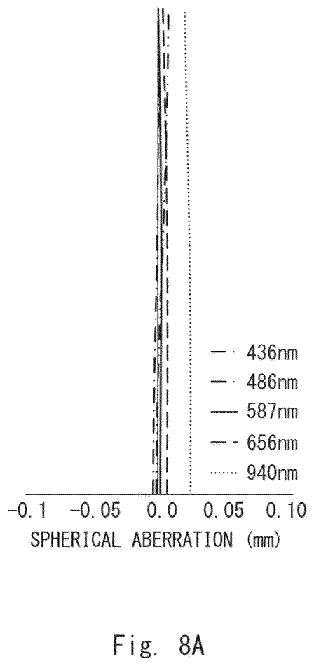

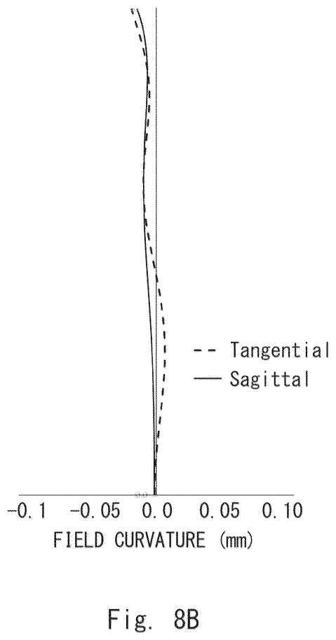

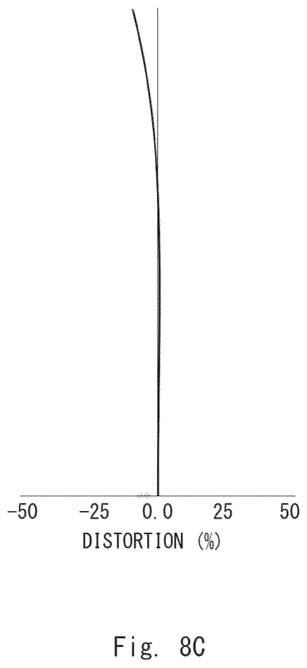

FIGS. 8A to 8C show a spherical aberration diagram (longitudinal aberration diagram), a field curvature diagram, and a distortion diagram in the imaging lens system 11 of Example 4. Since the description of each aberration diagram shown in FIGS. 8A to 8C is the same as that of FIGS. 2A to 2C, the description thereof will be omitted.

### Example 5

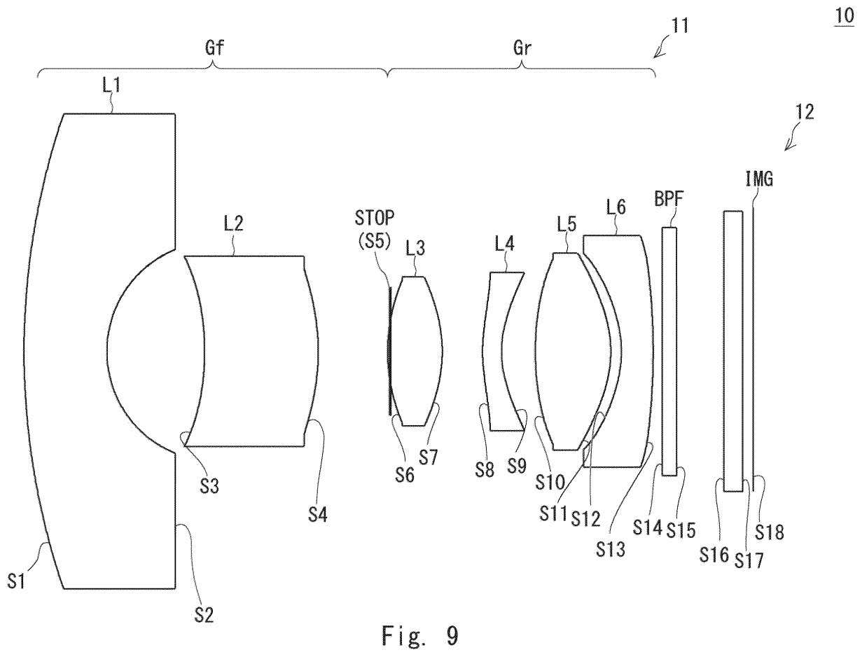

FIG. 9 is a cross-sectional view showing the camera module 10 according to Example 5. Since the imaging lens system 11 according to Example 5 has the same lens configuration as that of Example 1, descriptions thereof will be omitted. Hereinafter, property data of the imaging lens system 11 according to Example 5 will be described.

Table 9 shows lens data of each lens surface in the imaging lens system 11 according to Example 5. Since the items shown in Table 9 are the same as those in Table 1, descriptions thereof are omitted.

TABLE 9

| | Curvature | | | |
|---|---|---|---|---|
| | Radius | Thickness | | |
| Surface Number | (mm) | (mm) | nd | νd |
| Lens Surface S1 | 15.144 | 1.764 | 1.816 | 46.6 |
| Lens Surface S2 | 2.306 | 2.082 | | |
| Lens Surface S3 * | −5.450 | 2.414 | 1.635 | 24.0 |
| Lens Surface S4 * | −4.656 | 1.516 | | |
| Aperture Surface S5 | INF | −0.042 | | |
| Lens Surface S6 * | 3.727 | 1.158 | 1.438 | 94.5 |
| Lens Surface S7 * | −3.030 | 0.862 | | |
| Lens Surface S8 * | 3.755 | 0.403 | 1.661 | 20.4 |
| Lens Surface S9 * | 2.128 | 0.715 | | |
| Lens Surface S10 * | 5.815 | 1.601 | 1.537 | 56.4 |
| Lens Surface S11 * | −2.466 | 0.233 | | |
| Lens Surface S12 * | −2.458 | 0.670 | 1.635 | 24.0 |
| Lens Surface S13 * | −13.339 | 0.199 | | |
| BPF Surface S14 | INF | 0.300 | 1.517 | 64.2 |
| BPF Surface S15 | INF | 1.005 | | |
| Cover Surface S16 | INF | 0.400 | 1.517 | 64.2 |
| Cover Surface S17 | INF | 0.151 | | |
| IMG Surface S18 | INF | 0.000 | | |

Table 10 shows aspherical surface coefficients for defining aspherical surface shapes of aspherical lens surfaces in the imaging lens system 11 according to Example 5. In Table 10, the aspherical surface shape adopted for the lens surface is expressed by an expression similar to that in Example 1.

TABLE 10

| | k | α₄ | α₆ | α₈ |
|---|---|---|---|---|
| Lens Surface S3 | 0.000 | −3.84956E−03 | 3.52838E−04 | −9.27473E−05 |
| Lens Surface S4 | 0.000 | 3.02310E−03 | 1.58491E−04 | 7.57713E−05 |
| Lens Surface S6 | 0.000 | 8.80762E−04 | −5.80751E−04 | 0.00000E+00 |
| Lens Surface S7 | 0.000 | 9.69897E−03 | −1.00652E−04 | 0.00000E+00 |
| Lens Surface S8 | 0.000 | −4.03643E−02 | 6.16076E−03 | −7.89619E−04 |
| Lens Surface S9 | 0.000 | −5.38386E−02 | 9.24878E−03 | −1.76777E−03 |
| Lens Surface S10 | 0.000 | −4.32452E−04 | 1.37968E−03 | −1.29647E−04 |
| Lens Surface S11 | 0.000 | 2.12597E−02 | −5.43689E−05 | 9.71965E−05 |
| Lens Surface S12 | 0.000 | 2.23878E−02 | −8.31392E−04 | −7.51463E−05 |
| Lens Surface S13 | 0.000 | 2.46721E−03 | −4.71248E−04 | −2.74622E−05 |

| | α₁₀ | α₁₂ | α₁₄ | α₁₆ |
|---|---|---|---|---|
| Lens Surface S3 | 9.91045E−06 | −5.56212E−07 | 0.00000E+00 | 0.00000E+00 |
| Lens Surface S4 | −2.30939E−05 | 4.90846E−06 | 0.00000E+00 | 0.00000E+00 |
| Lens Surface S6 | 0.00000E+00 | 0.00000E+00 | 0.00000E+00 | 0.00000E+00 |
| Lens Surface S7 | 0.00000E+00 | 0.00000E+00 | 0.00000E+00 | 0.00000E+00 |
| Lens Surface S8 | 0.00000E+00 | 0.00000E+00 | 0.00000E+00 | 0.00000E+00 |
| Lens Surface S9 | 0.00000E+00 | 0.00000E+00 | 0.00000E+00 | 0.00000E+00 |
| Lens Surface S10 | 0.00000E+00 | 0.00000E+00 | 0.00000E+00 | 0.00000E+00 |
| Lens Surface S11 | 0.00000E+00 | 0.00000E+00 | 0.00000E+00 | 0.00000E+00 |
| Lens Surface S12 | 0.00000E+00 | 0.00000E+00 | 0.00000E+00 | 0.00000E+00 |
| Lens Surface S13 | 0.00000E+00 | 0.00000E+00 | 0.00000E+00 | 0.00000E+00 |

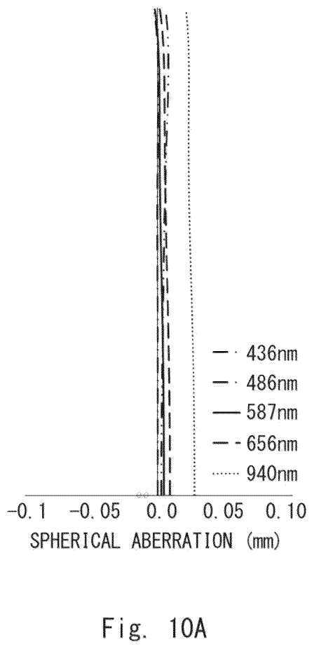

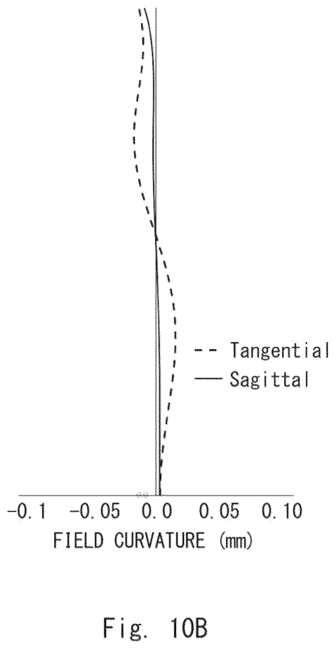

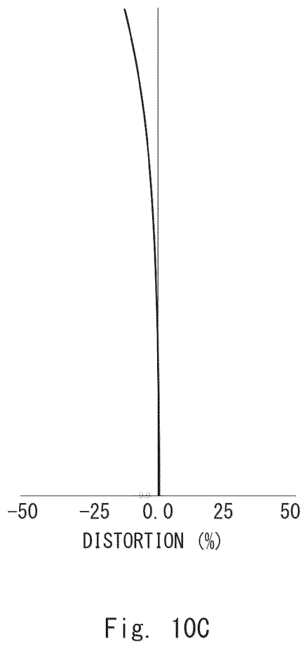

FIGS. 10A to 10C show a spherical aberration diagram (longitudinal aberration diagram), a field curvature diagram, and a distortion diagram in the imaging lens system 11 of Example 5. Since the description of each aberration diagram shown in FIGS. 10A to 10C is the same as that of FIGS. 2A to 2C, descriptions thereof will be omitted.

Table 11 shows a focal length f1 of the first lens L1, a focal length f2 of the second lens L2, a focal length f3 of the third lens L3, a focal length f4 of the fourth lens L4, a focal length f5 of the fifth lens L5, a focal length f6 of the sixth lens L6, a focal length f of an entire optical system of the imaging lens system 11, a value of f1/f, a value of f2/f, a value of f3/f, a value of f4/f, a value of f5/f, a value of f6/f, an Abbe's number vd2 for the d-line of the second lens, an Abbe's number vd3 for the d-line of the third lens, a value of f2/f3, and a value of f5/f6. In Table 11, the units of the focal length and the total track length are both mm. The focal lengths shown in Table 11 are calculated using a wavelength ray of 546.1 nm.

TABLE 11

| Example | 1 | 2 | 3 | 4 | 5 |
|---|---|---|---|---|---|
| f1 | −2.964 | −3.112 | −4.021 | −2.809 | −3.536 |
| f2 | 17.969 | 21.297 | 13.046 | 13.420 | 22.790 |
| f3 | 3.676 | 3.130 | 3.382 | 2.879 | 4.018 |
| f4 | −7.302 | −7.071 | −5.008 | −4.587 | −8.160 |
| f5 | 3.442 | 3.358 | 3.339 | 2.804 | 3.447 |
| f6 | −5.564 | −4.522 | −5.344 | −5.090 | −4.816 |
| f | 2.128 | 2.150 | 2.074 | 1.630 | 2.256 |
| f1/f | −1.4 | −1.4 | −1.9 | −1.7 | −1.6 |
| f2/f | 8.4 | 9.9 | 6.3 | 8.2 | 10.1 |
| f3/f | 1.7 | 1.5 | 1.6 | 1.8 | 1.8 |
| f4/f | −3.4 | −3.3 | −2.4 | −2.8 | −3.6 |
| f5/f | 1.6 | 1.6 | 1.6 | 1.7 | 1.5 |
| f6/f | −2.6 | −2.1 | −2.6 | −3.1 | −2.1 |
| νd2 | 24.0 | 24.0 | 24.0 | 24.0 | 24.0 |
| νd3 | 94.5 | 63.8 | 63.8 | 63.8 | 94.5 |
| f2/f3 | 4.89 | 6.81 | 3.86 | 4.66 | 5.67 |
| f5/f6 | −0.62 | −0.74 | −0.62 | −0.55 | −0.72 |

In Examples 1-5, since the imaging lens system 11 satisfies the Conditional Expressions (1)-(4), a wide-angle imaging lens system 11 that has sufficient brightness for sensing capabilities during the night-time and has a high resolution in a wide range of wavelength regions from visible light to near infrared light can be provided. Specifically, in Examples 1-5, the F value is 2.00 and the imaging lens system 11 has sufficient brightness. Further, in Examples 1-5, as shown in FIGS. 2A, 4A, 6A, 8A, and 10A, longitudinal aberrations can be optimally reduced in a wide range of wavelength regions from visible light to near infrared light. Further, in Examples 1-5, as shown in FIGS. 2A-2C, 4A-4C, 6A-6C, 8A-8C, and 10A-10C, various aberrations can be optimally reduced. Therefore, in Examples 1-5, the imaging lens system 11 has a high resolution in a wide range of wavelength regions from visible light to near infrared light. Further, in Examples 1-5, the angle of view of the imaging lens system 11 is 180°, which is large enough to capture not only an image of the exterior of the car but also an image of the interior of the car.

In Examples 1-5, the value of f6/f satisfies the above Conditional Expression (5), whereby the field curvature and the distortion generated in the first lens can be corrected. In fact, in Examples 1-5, as shown in FIGS. 2A-2C, 4A-4C, 6A-6C, 8A-8C, and 10A-10C, field curvatures and distortions can be optimally reduced.

In Examples 1-5, the value of f5/f6 satisfies the above Conditional Expression (6), whereby the chromatic aberrations in the entire optical system can be effectively corrected in the fifth lens and the sixth lens. In fact, in Examples 1-5, as shown in FIGS. 2A, 4A, 6A, 8A, and 10A, longitudinal aberrations can be optimally reduced in a wide range of wavelength regions from visible light to near infrared light.

In Examples 1-5, the value of f2/f3 satisfies the above Conditional Expression (7), whereby the spherical aberrations in the entire optical system can be effectively corrected. In fact, in Examples 1-5, as shown in FIGS. 2A, 4A, 6A, 8A, and 10A, longitudinal aberrations can be optimally reduced in a wide range of wavelength regions from visible light to near infrared light.

Further, since the camera module 10 includes the imaging lens system 11, a wide-angle camera module 10 that has sufficient brightness for sensing capabilities during the night-time and has a high resolution in a wide range of wavelength regions from visible light to near infrared light can be provided.

### Third Embodiment

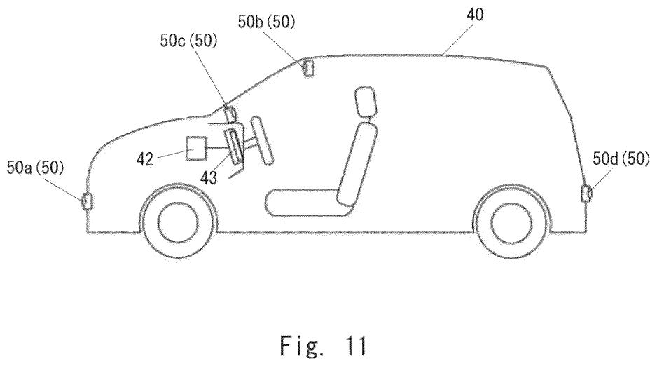

FIG. 11 is an overview diagram of a car 40 on which an in-vehicle system is mounted. The in-vehicle system includes capturing apparatuses 50 each including the imaging lens system 11 according to the first embodiment or second embodiment and a capturing element 12 for converting light converged therethrough into electrical signals. As shown in the drawing, the capturing apparatus 50 can be mounted on the car 40. FIG. 11 is an example arrangement showing positions on the car 40 where the capturing apparatuses 50 are mounted. The capturing apparatuses 50 mounted on the car 40 may also be referred to as on-board cameras and may be installed at various positions on the car 40. For example, a first capturing apparatus 50a may be arranged on or near the front bumper as a camera to monitor the front area of the car 40 as it travels. A second capturing apparatus 50b for monitoring the front area may be arranged near the inner rearview mirror inside the vehicle compartment of the car 40. A third capturing apparatus 50c may be arranged on the dashboard, inside the instrument panel or the like as a camera for monitoring the driver's driving condition. A fourth capturing apparatus 50d may be installed at the rear of the car 40 for monitoring the rear area of the car 40. The capturing apparatuses 50a and 50b may be referred to as front cameras. The third capturing apparatus 50c may be referred to as an in-camera. The fourth capturing apparatus 50d may be referred to as a rear camera. The capturing apparatuses 50 are not limited to these, but also include capturing apparatuses installed at various positions, such as a left side camera capturing images on the left rear side and a right side camera capturing images on the right rear side.

Image signals of the images captured by the capturing apparatuses 50 may be output to an information processing apparatus 42 and/or a display apparatus 43 or the like inside the car 40. The information processing apparatus 42 and display apparatus 43 constitute the in-vehicle system together with the capturing apparatuses 50. The information processing apparatus 42 inside the car 40 includes an apparatus that processes the image signals acquired by the capturing apparatuses 50, recognizes the recognition of various objects in the captured images, and assists the driver in driving. The information processing apparatus 42 also includes, but is not limited to, for example, a navigation apparatus, a collision damage reduction brake apparatus, a distance control apparatus, and a lane departure warning apparatus. The display apparatus 43 displays the images processed and output by the information processing apparatus 42, and may also receive the image signals directly from the capturing apparatuses 50. The display apparatus 43 may also employ, but is not limited to, a Liquid Crystal Display (LCD), an organic EL (Electro-Luminescence) display, and an inorganic EL display. The display apparatus 43 may display to an occupant such as the driver the image signals output from the capturing apparatuses 50 that capture images at positions difficult to be seen by the driver, such as a rear camera.

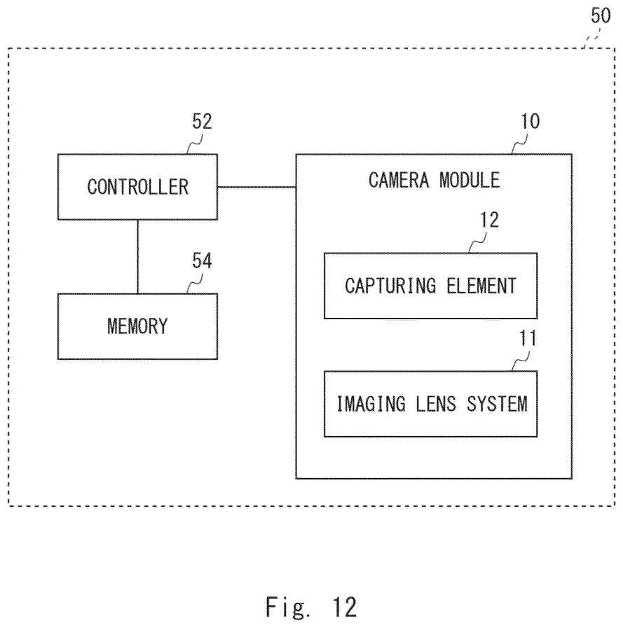

FIG. 12 shows the configuration of the capturing apparatus 50 constituting the in-vehicle system of FIG. 11. As shown in the drawing, the capturing apparatus 50 according to one embodiment includes a controller 52, a memory 54, and a camera module 10.

The controller 52 controls the camera module 10 and processes electrical signals output from the capturing element 12 of the camera module 10. The controller 52 may be configured as, for example, a processor. The controller 52 may also include one or more processors. The processor may include a general purpose processor that loads a specific program to perform a specific function, and a dedicated processor specialized in a specific process. The dedicated processor may include an application specific integrated circuit (IC). The application specific integrated circuit is also referred to as an ASIC. The processor may include a programmable logic device. A programmable logic device is also referred to as a PLD (Programmable Logic Device). A PLD may include a FPGA (Field-Programmable Gate Array). The controller 52 may be either a SoC (System-on-a-Chip) with one or more processors working together, or a SiP (System In a Package).

The memory 54 stores various information or parameters related to the operation of the capturing apparatuses 50. The memory 54 may be composed of, for example, a semiconductor memory and the like. The memory 54 may function as a work memory for the controller 52. The memory 54 may store the captured images. The memory 54 may store various parameters and the like for the controller 52 to perform detection processing based on the captured images. The memory 54 may be included in the controller 52.

As described above, the camera module 10 uses the capturing element 12 to capture a subject image formed through the imaging lens system 11, and outputs the imaged image. The image captured by the camera module 10 is also referred to as the captured image.

The capturing element 12 may be composed of, for example, a CMOS (Complementary Metal Oxide Semiconductor) image sensor, a CCD (Charge Coupled Device), or the like. The capturing element 12 has an imaging surface on which a plurality of pixels are arranged. Each pixel outputs a signal specified by current or voltage according to an incident light quantity. The signal output by each pixel is also referred to as imaging data.

The imaging data of all pixels may be read out by the camera module 10 and captured by the controller 52 as a captured image. The captured image read out for all pixels is also referred to as a maximum captured image. The imaging data of some pixels may be read out by the camera module 10 and captured as a captured image. In other words, the imaging data may be read out from pixels in a predetermined capture range. The imaging data read out from pixels in the predetermined capture range may be captured as a captured image. The predetermined capture range may be set by the controller 52. The camera module 10 may acquire the predetermined capture range from the controller 52. The capturing element 12 may capture an image of a predetermined capture range of the subject image formed through the imaging lens system 11.

Note that the present invention is not limited to the above-described examples, and they can be modified as appropriate without departing from the scope and spirit of the invention. For example, the use of the imaging lens system according to the present invention is not limited to on-board cameras and surveillance cameras, and instead can also be used for other uses such as cameras or the like used in small electronic apparatuses such as mobile phones.

This application is based upon and claims the benefit of priority from Japanese Patent Application No. 2023-000152, filed on Jan. 4, 2023, the disclosure of which is incorporated herein in its entirety by reference.

### INDUSTRIAL APPLICABILITY

It is possible to provide an imaging lens system, a camera module, an in-vehicle system, and a vehicle that have sufficient brightness for sensing capabilities during the night-time, a high resolution in a wide range of wavelength regions from visible light to near infrared light, and a wide angle.

### REFERENCE SIGNS LIST

10 CAMERA MODULE
11 IMAGING LENS SYSTEM
12 CAPTURING ELEMENT
40 CAR (VEHICLE)
42 INFORMATION PROCESSING APPARATUS (PROCESSING APPARATUS)
43 DISPLAY APPARATUS (OUTPUT APPARATUS)
50 CAPTURING APPARATUS
52 CONTROLLER
L1 FIRST LENS
L2 SECOND LENS
L3 THIRD LENS
L4 FOURTH LENS
L5 FIFTH LENS
L6 SIXTH LENS
STOP IRIS
Gf FRONT LENS GROUP
Gr REAR LENS GROUP
BPF VISIBLE/INFRARED LIGHT BAND-PASS FILTER
IMG FOCAL PLANE

1. An imaging lens system comprising, sequentially from an object side toward an image side:
a first lens having negative power with an object-side surface whose convex surface faces the object side; a second lens, which is a meniscus lens with the object-side surface whose concave surface faces the object side; an iris; a third lens with the object-side surface whose convex surface faces the object side and an image-side surface whose convex surface faces the image side; a fourth lens, which is a meniscus lens having negative power with the image-side surface whose concave surface faces the image side; a fifth lens having positive power with the object-side surface whose convex surface faces the object side; and a sixth lens having negative power with the object-side surface whose concave surface faces the object side, wherein
the imaging lens system satisfies the following Conditional Expressions (1) to (4):
$$5.5 < f 2 / f < 12. \qquad ( 1 )$$
$$- 4. < f 4 / f < - 2. \qquad ( 2 )$$
$$vd 2 < 30 \qquad ( 3 )$$
$$vd 3 > 60 \qquad ( 4 )$$
where f2 is defined as a focal length of the second lens, f4 is defined as a focal length of the fourth lens, f is defined as a focal length of the entire optical system, vd2 is defined as an Abbe's number for a d-line of the second lens, and vd3 is defined as an Abbe's number for a d-line of the third lens.

2. The imaging lens system according to claim 1, wherein the imaging lens system satisfies the following Conditional Expression (5):
$$- 3.5 < f 6 / f < - 2.1 \qquad ( 5 )$$
where f6 is defined as a focal length of the sixth lens.

3. The imaging lens system according to claim 1, wherein the imaging lens system satisfies the following Conditional Expression (6):
$$- 0.8 < f 5 / f 6 < - 0.5 \qquad ( 6 )$$
where f5 is defined as a focal length of the fifth lens and f6 is defined as a focal length of the sixth lens.

4. (canceled)

5. The imaging lens system according to claim 1, wherein the imaging lens system satisfies the following Conditional Expression (7):
$$3.5 < f 2 / f 3 < 7.5 \qquad ( 7 )$$
where f3 is defined as a focal length of the third lens.

6.-8. (canceled)

9. A camera module comprising:
the imaging lens system according to claim 1; and
a capturing element configured to convert light condensed through the imaging lens system into an electrical signal.

10. An in-vehicle system mounted on a car comprising:
the camera module according to claim 9; and
an information processing apparatus configured to process a captured image output from the capturing element of the camera module and recognize an object in the captured image.

11. A vehicle on which the in-vehicle system according to claim 10 is mounted, further comprising an output apparatus configured to output information to an occupant,
wherein the information processing apparatus is configured to output recognition information about the object to the output apparatus.
